(19) United States
(12) Patent Application Publication
(10) Pub. No.: US 2013/0048210 A1
(43) Pub. Date: Feb. 28, 2013

(54) Method for cutting a snowboard using a jet of fluid, such as water

(71) Applicant: Nicholas Lee Parko, Seattle, WA (US)

(72) Inventor: Nicholas Lee Parko, Seattle, WA (US)

(21) Appl. No.: 13/221,004

(22) Filed: Aug. 30, 2011

(51) Int. Cl. B32B 38/04; B05D 3/12

(52) U.S. Cl. 156/250; 427/290

(57) ABSTRACT

The invention is directed to a method of cutting a productions snowboard, to create a splitboad, using a waterjet. A waterjet is a commonly used cutter the employs the use of high pressure water to erode the material and as such make fine cuts through most materials. The waterjet cut is clean and much narrower than when using a saw, is safer and as a result of it being narrower, preserves the snowboard graphics. A splitboard is a snowboard that doubles as skis making it easier for a snowboarder to access backcountry terrain.

### FIELD OF THE INVENTION

The present invention relates to a method for cutting a snowboard using a jet of fluid, such as water.

### BACKGROUND OF THE INVENTION

It is conventionally known that snowboarders enjoy making tracks in fresh snow but typically need to pack the snowboard and boots on their back and use snow shoes to traverse the deep powder. The snowboarder would then need to carry these snow shoes down the mountain while snowboarding. Splitboards have solved this dilemma by making the snowboard into snow shoes and a snowboard combined. The splitboard is split down the middle lengthwise in the fore aft direction. A binding is attached to each half allowing a snowboarder to move like a cross country skier. When desired, the two halves of the splitboard can be reattached with metal clips into a continuous snowboard and can be ridden through the deep powder back down the mountain.

Factory assembled splitboards are very expensive and most snowboarders can't afford them. As a result companies have made kits for making home built splitboards using a production snowboard and the additional hardware included within the kit. The kit requires that a table saw or circular saw is used to cut the snowboard in half. This is very dangerous and can ruin the snowboard because the lower perimeter of the board is lined with a metal edge and throughout the snowboard are threaded metal inserts. Also, a saw is undesirable because it makes a rough cut and removes a wide band of material from the snowboard.

### SUMMARY OF THE INVENTION

The present invention is therefore directed to a method of cutting a productions snowboard using a waterjet. A waterjet is a commonly used cutter that employs the use of high pressure water to erode the material and as such make fine cuts through most materials. The waterjet cut is clean and much narrower than when using a saw. Therefore, the pictures and designs on the board will not look different after the snowboard is cut and the pieces are put back together. Also, a waterjet allows for cutting many different materials in a single cut including thin metal, fiberglass laminate, wood laminate, hardened metal inserts, and plastic. A waterjet also provides safety as saws can catch on metal parts or bind in the snowboard and cause injury to the user, whereas a waterjet will pass over hardened areas and it can't bind in the snowboard.

The waterjet process involves mounting the snowboard to a backing material such as Oriented Strand Board (OSB), plywood, magnacite or another stiff material. The board is mounted to the backing material using clamps or vices which can be tightly installed without damaging the surface of the snowboard and can be easily removed when the processing is complete. The edges on either side of the cut will be exposed to the weather and must be sealed with a waterproofing sealant such as polyurethane. Brackets can be purchased that attach to each side of the splitboard and allow the splitboard to be reassembled back to its whole configuration.

### BRIEF DESCRIPTION OF THE DRAWINGS

FIG. 1 is the isometric view of the snowboard fixtured to the bed of a waterjet cutter.

FIG. 2 is the section cut of a typical snowboard showing the various materials and parts within the cross section.

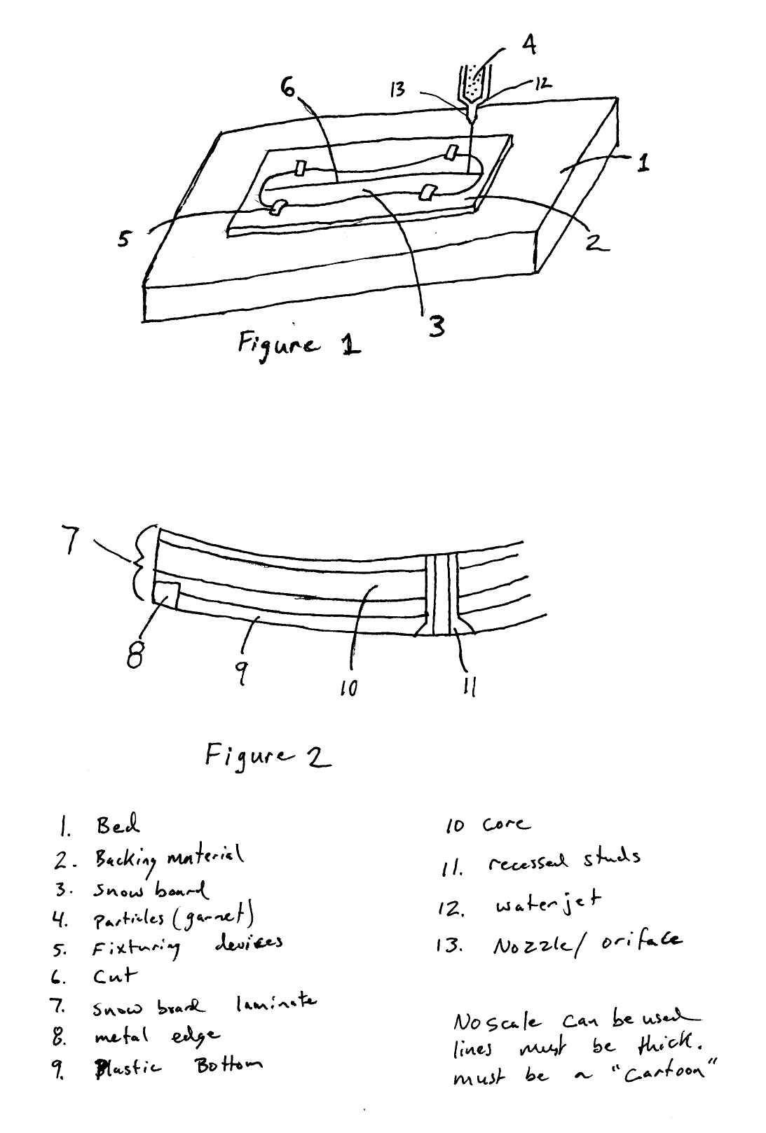

### DETAILED DESCRIPTION OF THE PREFERRED EMBODIMENT

The preferred method for cutting a factory snowboard 3 comprises, fixturing the snowboard to a backing media 2, aligning the snowboard on a cutting bed 1 to create a local axis from which all measurements will be taken, cutting the board with a high pressure stream of water 14, and then coating the core 10 exposed by the cut with a Urethane coating.

The backing media 2 are materials commonly known in commercial building and can be Oriented Strand Board (OSB) or ½ inch to ¾ inch Plywood, or any other stiff and flat material. The snowboards can also be cut without using any backing material.

Waterjet cutters are typically numerically controlled and therefore a part must be aligned to a local axis of the machine to allow the machine to know how to align the numerical data relative to the part. The snowboard is therefore aligned on a cutting bed 1 and oriented to the waterjet axis. Temporary fixtures 5 are used to hold the snowboard in place during the cutting operation. The temporary fixtures can be C-clamps, vices or other clamping devices which can be tightly installed without damaging the surface of the snowboard and can be easily removed when the processing is complete. The temporary fixtures 5 must be placed around the periphery to insure the snowboard doesn't move as it is cut in half. The preferred fixturing method is clamping both sides of the snowboard where force is applied approximately 3 inches from the edge.

The split cut 6 is preferable exactly in the center of the snowboard along its length and perpendicular to the flatwise or Inner Mold Line (IML) 15 of the board. The cut can be off center to avoid metal inserts 11 in the board or to meet the needs of a customer.

The waterjet 12 preferably uses water as the cutting fluid with garnet sand as an abrasive 4 within the water. Water without an abrasive can be used but feed rate must be adjusted accordingly. The preferred nozzle 13 size is 0.04 inches but may be in the range of 0.010 to 0.100 inches. The diameter of the high pressure stream of water 14, which is determined by the orifice size, is preferably 0.014 inches but may be 0.010 to 0.100 inches

The feed rate of the waterjet is preferably 5 inches per second through the snowboard laminate 7 except in places where the metal edge 8 is or where there are recessed metal inserts 11. The feed rate through the edge metal 8 and the recessed metal inserts 11 is slowed to 2 inches per second. Speed rates of up to 10 inches per second down to 0.1 inch per second will work. Slower feed rates waste time and faster feed rates cut sloppily and shred the plastic bottom 9 resulting in unnecessary finishing work prior to sealing.

The exposed core 10 must be sealed with a waterproof sealant. The preferred sealant is 5 coats of Polyurethane but more or less may be applied. Other sealants include: silicon based sealants; waxes; resins; water-based, acrylic; oil-based sealants; oil-based penetrating sealant with alkyd and acrylic; and oil-based, acrylic.

Having described the invention, what is claimed is as follows:

1. A method for dividing a snowboard comprising,
aligning the snowboard on a cutting bed to a local axis,
cutting the snowboard with a means for cutting laminate material,
coating the core exposed by the cutting with a means for sealing.

2. The method of claim 2 where a cut is made along the snowboards length essentially perpendicular to an Inner Mold line (IML) and through the center of said snowboard.

3. The method of claim 3 wherein the cutting means is a waterjet cutter with a fluid as the cutting means.

4. The method of claim 4 wherein the waterjet cutter has a nozzle diameter between 0.010 and 0.100 inches.

5. The method of claim 3 or 4 wherein the waterjet cutter uses an abrasive particle in the fluid cutting means.

6. A method for dividing a snowboard comprising,
fixturing the snowboard to a backing media,
aligning the snowboard on a cutting bed to a local axis,
cutting through the centerline of the snowboard with a waterjet cutter,
coating the core exposed by the cutting with a means for sealing.

7. The method of claim 6 where the backing media is Oriented Strand Board (SB).

8. The method of claim 7 where a cut is made along the snowboards length essentially perpendicular to an Inner Mold line (IML) and through the center of said snowboard.

9. The method of claim 6 wherein the cutting means is a waterjet cutter with a fluid as the cutting means.

10. The method of claim 9 wherein the waterjet cutter has a nozzle diameter between 0.010 and 0.100 inches.

11. The method of claim 9 or 10 wherein the waterjet cutter uses an abrasive particle in the fluid cutting means.
